(19) United States
(12) Patent Application Publication
(10) Pub. No.: US 2022/0282039 A1
(43) Pub. Date: Sep. 8, 2022

(54) MOISTURE-CURABLE COMPOSITION AND METHOD FOR PRODUCING THE MOISTURE-CURABLE COMPOSITION

(71) Applicant: WACKER CHEMIE AG, Munich (DE)

(72) Inventor: Takuya Tabata, Chikusei-shi (JP)

(73) Assignee: Wacker Chemie AG, Munich (DE)

(21) Appl. No.: 17/626,530

(22) PCT Filed: Mar. 16, 2021
(86) PCT No.: PCT/EP2021/056612

§ 371 Date: Jan. 12, 2022

(30) Foreign Application Priority Data
Mar. 18, 2020 (JP) 2020-048361

(51) Int. Cl. C08G 65/336; C08G 77/00; C08K 5/20; C08K 3/36; C08K 9/04; C08L 91/06

(52) U.S. Cl. CPC C08G 65/336; C08G 77/80; C08K 5/20; C08K 3/36; C08K 9/04; C08L 91/06

(57) ABSTRACT

The present invention relates to a moisture-curable composition that is a compound containing a silane-terminated modified polymer as a main component, has both excellent workability due to low viscosity at a high shear rate and sufficiently high thixotropic properties due to high viscosity at a low shear rate, and during attachment of a heavy object such as a ceramic tile to a substantially vertical face of a construction or the like, can prevent sagging of the ceramic tile. The moisture-curable composition of the present invention is a moisture-curable composition prepared by adding (A) a polymer having a hydrophobic moiety and a hydrophilic moiety as a main component, (B) a diluent having a predetermined viscosity range, (C) hydrophobized inorganic particles, and (D) a thixotropic agent having a hydrophobic moiety and a hydrophilic moiety, whereby the composition exhibits performances of suppressing the viscosity at a high shear rate to a value equal to or lower than a certain value, and at the same time, increasing the viscosity at a low shear rate.

### TECHNICAL FIELD

The present invention relates to a moisture-curable composition that is a compound containing, as a main component, a polymer having a hydrophobic moiety and a hydrophilic moiety, in particular, a silane-terminated modified polymer, has both excellent workability due to low viscosity at a high shear rate and sufficiently high thixotropic properties due to high viscosity at a low shear rate, and during attachment of a heavy object such as a ceramic tile to a substantially vertical face of a construction or the like, can prevent sagging of the ceramic tile.

### BACKGROUND ART

A polymer having a hydrolyzable silyl group is known as a moisture-curable polymer and is used in a wide variety of fields for many use applications of industry, architecture, and construction, such as an adhesive, a sealing material, and a coating material including a coating-film water-proof material and a paint.

For the polymer having a hydrolyzable silyl group, excellent workability at a low viscosity is required during application of each of the materials in the fields described above. After the moisture-curable composition is applied to a substantially vertical face, in particular, after the moisture-curable composition is used as an adhesive to attach a heavy object such as a ceramic tile, a property of keeping the heavy object at a fixation position without falling (prevention of shifting) until the moisture-curable composition is cured is required.

However, when a diluent such as a plasticizer is added to improve the workability, the thixotropic properties (thixotropy) are also deteriorated. Therefore, when a paint, an adhesive, or the like is applied to a substantially vertical face, a problem about shifting, and in particular, a problem in which a heavy object such as the ceramic tile cannot be kept at the fixation position and the tile falls arise.

A method for solving the problem about shifting by imparting thixotropic properties to the moisture-curable composition has been proposed.

Specifically, addition of a thixotropic agent such as an amide wax and a hydrogenated castor oil (Patent Literature 1), use of precipitated calcium carbonate (Patent Literature 2), and optimization of ratio of precipitated calcium carbonate to surface-untreated heavy calcium carbonate (Patent Literature 3) have been proposed. They refer to only the thixotropic properties on a level face of a floor finishing material or the like and does not refer to the ceramic tile-shifting property on a vertical face.

### CITATION LIST

### Patent Literature

Patent Literature 1: Japanese Patent Application Laid-Open No. 2002-265914

Patent Literature 2: Japanese Patent Application Laid-Open No. 2015-086354

Patent Literature 3: Japanese Patent Application Laid-Open No. 2019-218466

### SUMMARY OF INVENTION

### Technical Problem

The present invention has been made in view of the foregoing circumstances, and an object of the present invention is to propose a moisture-curable composition that has both excellent workability at a low viscosity during application and sufficiently high thixotropic properties, and during attachment of a heavy object such as a ceramic tile to a substantially vertical face of a construction or the like, can prevent sagging of the ceramic tile.

### Solution to Problem

The present inventors have intensively studied, and as a result found a moisture-curable composition that is a compound, in particular, containing a silane-terminated modified polymer as a main component and expresses performances of decreasing the viscosity at a high shear rate and increasing the viscosity at a low shear rate when a diluent having a predetermined viscosity range, surface-treated, hydrophobized inorganic particles, and a thixotropic agent having a hydrophobic moiety and a hydrophilic moiety are mixed. Thus, the present invention has been completed.

In the moisture-curable composition of the present invention, a network is formed in a system between the hydrophobized inorganic particles and a polymer having a hydrophobic moiety and a hydrophilic moiety, in particular, the silane-terminated modified polymer and the diluent having a predetermined viscosity range through a Van der Waals force, so that the viscosity of the whole system is increased.

In the present invention, the hydrophobic moiety of the polymer is not particularly limited as long as it is a moiety containing a hydrophobic group or a bond having locally low polarity. For example, the hydrophobic moiety corresponds to an alkyl group, a phenyl group, a C—C bond in a polyether chain, a polydimethylsiloxane, or the like.

In contrast, the hydrophilic moiety is not particularly limited as long as it is a moiety containing a hydrophilic group or a bond having locally high polarity. For example, the hydrophilic moiety corresponds to a hydroxyl group, an alkoxy group, a polyether bond, an ester bond, a urethane bond, an amide bond, or the like.

Since the hydrophobized inorganic particles usually have a particle diameter larger than the thixotropic agent, a comparatively dense network is formed in the system, so that the viscosity of the whole system is increased. Therefore, characteristics such as an increase in viscosity at both a high shear rate and a low shear rate are imparted to the moisture-curable composition.

On the other hand, the hydrophilic moiety such as a hydrogen bond in the molecule of the thixotropic agent having a hydrophobic moiety and a hydrophilic moiety forms a network due to an interaction with the hydrophilic moieties of the polymer and the diluent, or the like, so that the viscosity of the whole system is increased. Since the thixotropic agent, in particular, an amide wax has a particle size smaller than the hydrophobized inorganic particles and has a needle shape, a comparatively sparse network is formed in the system, and the viscosity of the whole system is mildly increased. Therefore, characteristics of no large contribution to viscosity at a high shear rate and large contribution to viscosity of the moisture-curable composition at a low shear rate are imparted by the thixotropic agent.

When the viscosity of the diluent falls within a range of equal to or larger than a predetermined value, the diluent is considered to exhibit characteristics of an effective increase in viscosity at a low shear rate.

Use of these components in combination can achieve the moisture-curable composition that has both excellent workability due to a low viscosity at a high shear rate and sufficiently high thixotropic properties due to a high viscosity at a low shear rate in a use application such as an adhesive, and during attachment of a heavy object such as a ceramic tile to a substantially vertical face of a construction or the like, can prevent sagging of the ceramic tile.

In the moisture-curable composition as one example of the present invention, a network is formed in a system through a Van der Waals force of secondary aggregates of hydrophobized silica having a particle diameter of about 10 μm between the secondary aggregates, and a silane-terminated modified polymer having a hydrophilic moiety and a hydrophilic moiety and a diluent having a viscosity range of higher than 10 mPa·s, and the viscosity of the system is increased. Through a hydrogen bond between amide bonds in a needle-shaped particle molecular chain of several tens to several hundreds nanometers that is activated by heating an amide wax as a thixotropic agent, an interaction with the hydrophilic moiety of various components, or the like, a network is formed, so that the viscosity of the system is increased.

Since the hydrophobized silica has a particle size larger than the amide wax, a comparatively dense network is formed in the system, so that the viscosity of the whole system is increased. Therefore, the hydrophobized silica has characteristics of capability in increasing a viscosity at both a high shear rate and a low shear rate.

Since the amide wax has a particle size smaller than the hydrophobized silica and has a needle shape, the amide wax has characteristics of forming a comparatively sparse network in the system and mildly increasing the viscosity of the whole system. Therefore, the amide wax has characteristics of no large contribution to viscosity at a high shear rate and large contribution to viscosity at a low shear rate.

When the viscosity of the diluent falls within a range of higher than 10 mPa·s, the diluent is considered to exhibit characteristics of effectively increasing the viscosity at a low shear rate.

In particular, it is considered that the hydrophobized silica effectively forms a network with the hydrophobic moieties of the silane-terminated modified polymer and the diluent, and the amide wax effectively forms a network with the hydrophilic moieties of the silane-terminated modified polymer and the diluent.

Accordingly, when the hydrophobized silica and the amide wax, the silane-terminated modified polymer having a hydrophobic moiety and a hydrophilic moiety and the diluent, and the diluent having a viscosity range of higher than 10 mPa·s are used in combination, the viscosity at a high shear rate can be reduced to a value equal to or lower than a certain value, and at the same time, the viscosity at a low shear rate can be effectively increased.

That is, use of these components in combination can achieve the moisture-curable composition that has both excellent workability due to low viscosity at a high shear rate and sufficiently high thixotropic properties due to high viscosity at a low shear rate in a use application such as an adhesive, and during attachment of a heavy object such as a ceramic tile to a substantially vertical face of a construction or the like, can prevent sagging of the ceramic tile.

### DESCRIPTION OF EMBODIMENTS

Hereinafter, the present invention will be described in detail.

A moisture-curable composition of the present invention may have a form of at least one part or more liquids. The moisture-curable composition may have any aspect, form, or composition as long as a cured product of the composition is finally obtained by curing with moisture. The moisture-curable composition may be a single component or a mixture of two or more kinds of components. An exemplary moisture-curable composition is a coating material containing a polymer having an alkoxysilyl group that is hydrolyzed by moisture to produce a siloxane bond, resulting in curing.

The moisture-curable composition is not particularly limited as long as it contains (A) a polymer having a hydrophobic moiety and a hydrophilic moiety as a main component, (B) a diluent having a predetermined viscosity range, (C) hydrophobized inorganic particles, and (D) a thixotropic agent having a hydrophobic moiety and a hydrophilic moiety.

The polymer (A) may be any compound as long as it has a hydrophobic moiety and a hydrophilic moiety, and examples thereof may include a polyurethane, a polyester, and a polyether.

As for the polymer (A), a moisture-curable composition containing a silane-terminated modified polymer represented by the following general formula (1) typically exhibits excellent performances as various coating materials.

Y—[(CR¹₂)_{b}—SiRₐ(OR²)₃₋ₐ]ₓ (1)

(In the formula, Y is an x-valent organic polymer group bonded via nitrogen, oxygen, sulfur or carbon, and containing a polyoxyalkylene or a polyurethane as a polymer chain,

R may be the same or different and is a monovalent, optionally substituted SiC-bonded hydrocarbon group,

R¹ may be the same or different and is a hydrogen atom or a monovalent, optionally substituted hydrocarbon group in which a carbon atom can be boned to nitrogen, phosphorus, oxygen, sulfur or a carbonyl group,

R² may be the same or different and is a hydrogen atom or a monovalent, optionally substituted hydrocarbon group,

x is an integer of 1 to 10,

a is 0, 1, or 2, and

b is an integer of 1 to 10.)

The end group of the polymer (A) may be a group represented by the general formula (2) or (3):

—O—C(═O)—NH—(CR¹₂)_{b}—SiRₐ(OR²)₃₋ₐ (2)

—NH—C(═O)—NR′—(CR¹₂)_{b}—SiRₐ(OR²)₃₋ₐ (3)

(in the formulas, each of the groups and subscripts has one of the definitions specified above for them,

R may be the same or different and is a monovalent, optionally substituted SiC-bonded hydrocarbon group, and

R′ may be the same or different and has a given definition for R.)

The silane-terminated modified polymer has a hydrophobic moiety and a hydrophilic moiety. The hydrophobized silica effectively forms a network through a Van der Waals force with the hydrophobic moiety thereof, and the amide wax effectively forms a network through a hydrogen bond between amide bonds or an interaction with the hydrophilic moieties of various components.

In the present invention, the hydrophobic moiety is not particularly limited as long as it is a moiety containing a hydrophobic group or a bond having locally low polarity. For example, the hydrophobic moiety corresponds to an alkyl group, a phenyl group, a C—C bond in a polyether chain, a polydimethylsiloxane, or the like.

In contrast, the hydrophilic moiety is not particularly limited as long as it is a moiety containing a hydrophilic group or a bond having locally high polarity. For example, the hydrophilic moiety corresponds to a hydroxyl group, an alkoxy group, a polyether bond, an ester bond, a urethane bond, an amide bond, or the like.

The form and composition content of the moisture-curable composition containing the silane-terminated modified polymer represented by the general formula (1) as a coating material composition in coating of various substrates in various use applications are not limited.

When the moisture-curable composition containing the silane-terminated modified polymer is applied to a substrate for a typical use application, such as an architectural material or an industrial construction, the following composition is preferable.

(A) a silane-terminated modified polymer represented by the general formula (1): 5 to 100 parts by mass,

(B) a diluent: 5 to 100 parts by mass,

(C) a hydrophobized inorganic particle: 0.1 to 20 parts by mass,

(D) a thixotropic agent: 0.1 to 10 parts by mass,

(E) an amine compound: 0.01 to 10 parts by mass,

(F) a dehydrating agent: 0 to 10 parts by mass,

(G) a stabilizer: 0.01 to 5 parts by mass,

(H) a filler: 0 to 80 parts by mass, and

(I) a catalyst: 0 to 5 parts by mass

The amount in parts by mass of each component represents the amount in parts by mass of each component relative to 100 parts by mass of the whole moisture-curable composition.

The polymer (A) as the silane-terminated modified polymer is a major agent of the moisture-curable composition. The polymer (A) is a component for forming a coating film by moisture after coating.

The polymer (A) is commercially available as a product or may be prepared by common chemical processes. The polymer (A) may be a simple substance or a mixture of two or more kinds in combination.

Examples of the groups R may include an alkyl group, e.g., a methyl group, an ethyl group, an n-propyl group, an isopropyl group, a 1-n-butyl group, a 2-n-butyl group, an isobutyl group, a tert-butyl group, an n-pentyl group, an isopentyl group, a neopentyl group, and a tert-pentyl group; a hexyl group, e.g., an n-hexyl group; a heptyl group, e.g., an n-heptyl group; an octyl group, e.g., an n-octyl group, an isooctyl group, and a 2,2,4-trimethylpentyl group; a nonyl group, e.g., an n-nonyl group; a decyl group, e.g., an n-decyl group; a dodecyl group, e.g., an n-dodecyl group; an octadecyl group, e.g., an n-octadecyl group; a cycloalkyl group, e.g., a cyclopentyl group, a cyclohexyl group, a cycloheptyl group, and a methylcyclohexyl group; an alkenyl group, e.g., a vinyl group, a 1-propenyl group, and a 2-propenyl group; an aryl group, e.g., a phenyl group, a naphthyl group, an anthryl group, and a phenanthryl group; an alkaryl group, e.g., o-, m-, and p-tolyl groups, a xylyl group, and an ethylphenyl group, and an aralkyl group, e.g., a benzyl group, and α- and β-phenylethyl groups.

Examples of substituted groups R may include a haloalkyl group, e.g., a 3,3,3-trifluoro-n-propyl group, a 2,2,2,2′,2′,2′-hexafluoroisopropyl group, and a heptafluoroisopropyl group, and a haloaryl group, e.g., o-, m- and p-chlorophenyl groups.

The group R preferably includes a monovalent hydrocarbon group which is optionally substituted by a halogen atom and has 1 to 6 carbon atoms, more preferably an alkyl group having 1 or 2 carbon atoms, and more particularly a methyl group.

Examples of the group R¹ may include a hydrogen atom, groups specified for R, and an optionally substituted hydrocarbon group bonded to a carbon atom by nitrogen, phosphorus, oxygen, sulfur, carbon, or a carbonyl group.

R¹ is preferably a hydrogen atom or a hydrocarbon group having 1 to 20 carbon atoms, and more particularly a hydrogen atom.

Examples of the group R² may include a hydrogen atom and those specified for the group R.

The group R² is preferably a hydrogen atom or an alkyl group which is optionally substituted by a halogen atom and has 1 to 10 carbon atoms, more preferably an alkyl group having 1 to 4 carbon atoms, and more particularly a methyl group or an ethyl group.

It should be understood that the polymer which becomes the base of the polymer group Y in the present invention includes all polymers in which at least 50%, preferably at least 70%, more preferably at least 90%, of the total bonds in the main chain are carbon-carbon, carbon-nitrogen, or carbon-oxygen bonds.

The polymer group Y preferably includes an organic polymer group, which includes, as a polymer chain, a polyoxyalkylene, e.g., a polyoxyethylene, a polyoxypropylene, a polyoxybutylene, a polyoxytetramethylene, a polyoxyethylene-polyoxypropylene copolymer, and a polyoxypropylene-polyoxybutylene copolymer; a hydrocarbon polymer, e.g., a polyisobutylene, a polyethylene, or a copolymer of a polypropylene and a polyisobutylene with isoprene; a polyisoprene; a polyurethane; a polyester, a polyamide; a polyacrylate; a polymethacrylate; and a polycarbonate. The polymer group Y is preferably bonded to one group or more groups of —[(CR¹₂)_{b}—SiRₐ(OR²)₃₋ₐ] by at least one of —O—C(═O)—NH—, —NH—C(═O)—, —NH—C(═O)—NH—, —NR′—C(═O)—NH—, NH—C(═O)—NR′—, —NH—C(═O)—, —C(═O)—NH—, —C(═O)—O—, —O—C(═O)—, —O—C(═O)—O—, —S—C(═O)—NH—, —NH—C(═O)—S—, —C(═O)—S—, —S—C(═O)—, —S—C(═O)—S—, —C(═O)—, —S—, —O—, and —NR′—. Here, R′ may be the same or different, has the definition given for R, or may be the group of —CH(COOR″)—CH₂—COOR″ in which R″ may be the same or different and has the definition given for R.

Examples of the group R′ may include a cyclohexyl group, a cyclopentyl group, an n-propyl group, an isopropyl group, an n-butyl group, an isobutyl group, a tert-butyl group, various stereoisomers of pentyl, hexyl and heptyl groups, and a phenyl group.

The group R′ is preferably a group of —CH(COOR″)—CH₂—COOR″ or an optionally substituted hydrocarbon group having 1 to 20 carbon atoms, more preferably a straight, branched or cycloalkyl group having 1 to 20 carbon atoms, or an aryl group which has 6 to 20 carbon atoms and is optionally substituted by a halogen atom.

The group R″ is preferably an alkyl group having 1 to 10 carbon atoms, and more preferably a methyl group, an ethyl group, or a propyl group.

More preferably, the group Y in the formula (1) includes a polyurethane group and a polyoxyalkylene group, and more preferably a polyoxypropylene-containing urethane group or a polyoxypropylene group.

Herein, the polymer (A) may have a group of —[(CR¹₂)_{b}—SiRₐ(OR²)₃₋ₐ)] bonded to any desirable position in the polymer, for example, to a position within a chain and/or a terminal thereof, preferably to a position within a chain and a terminal thereof, and more preferably to a terminal thereof, in the manner described herein.

The end groups of the polymer (A) are preferably those represented by the general formula (2) or general formula (3):

—O—C(═O)—NH—(CR¹₂)_{b}—SiRₐ(OR²)₃₋ₐ (2)

—NH—C(═O)—NR′—(CR¹₂)_{b}—SiRₐ(OR²)₃₋ₐ (3)

(in the formulas, each of the groups and subscripts has one of the definitions specified above for them,

R may be the same or different and is a monovalent, optionally substituted SiC-bonded hydrocarbon group, and

R′ may be the same or different and has a given definition for R.

In one particularly preferable embodiment of the present invention, the polymer (A) includes, in all cases, a silane-terminated polyether and a silane-terminated polyurethane having a dimethoxymethylsilyl, trimethoxysilyl, diethoxymethylsilyl, or triethoxysilyl terminal group bonded by a —O—C(═O)—NH—(CR¹₂)_{b} group or a —NH—C(═O)—NR′—(CR¹₂)_{b} group (R′, R¹, and b have one of the definitions specified above), and more particularly includes a silane-terminated polypropylene glycol and a silane-terminated polyurethane.

The average molar mass Mₙ of the polymer (A) is preferably at least 400 g/mol, more preferably at least 600 g/mol, and more particularly at least 800 g/mol, and is preferably less than 30,000 g/mol, more preferably less than 19,000 g/mol, and more particularly less than 13,000 g/mol.

The viscosity of the polymer (A) is preferably at least 0.2 Pa·s, more preferably at least 1 Pa·s, and very preferably at least 5 Pa·s, and is preferably 1,000 Pa·s or lower, and more preferably 700 Pa·s or lower, as measured at 20° C. in each case.

In a first particularly preferable embodiment of the present invention, the polymer (A) has, as a polymer group Y, a linear or branched polyoxyalkylene group, and more preferably a polyoxypropylene group in which a chain terminal is preferably bonded to a group or a plurality of groups of —[(CR¹₂)_{b}—SiRₐ(OR²)₃₋ₐ] through —O—C(═O)—NH—. Herein, preferably at least 85%, more preferably at least 90%, and more particularly at least 95% of all the chain terminals are bonded to a group of —[(CR¹₂)_{b}—SiRₐ(OR²)₃₋ₐ] through —O—C(═O)—NH—. The polyoxyalkylene group Y has an average molecular weight (Mn) of 200 to 30,000, and preferably 1,000 to 20,000. An appropriate method for producing such a polymer (A) and examples of the polymer (A) itself are also known, and are described in publications including EP1535940B1 and EP1896523B1 included in the disclosure of this specification. For example, a corresponding silane-terminated polymer is also commercially available under the name GENIOSIL (registered trademark) STP-E from Wacker Chemie AG.

In chemical synthesis of the polymer (A), for example, the polymer (A) can be synthesized by various known production methods including an addition reaction such as hydrosilylation, Michael addition, or Diels-Alder addition, or a reaction of an isocyanate-functional compound with a compound containing an isocyanate-reactive group.

The content of the polymer (A) in the whole composition is preferably within a range of 5 to 90 parts by mass. When the content is less than 5 parts by mass, large amounts of components other than the major agent remain in the composition, the composition does not exert sufficient performance, the amount of a polymer matrix to be formed is insufficient, mechanical properties to be required such as tensile strength, elongation, and tear strength are insufficient, defects of a cured product such as poor adhesion and cracking of a film are caused, and the composition may be adversely affected by the other components. The content of the polymer (A) is more preferably within a range of 10 to 60 parts by mass.

In order to improve the stirring efficiency during production due to a decrease in viscosity, improve the property of filling containers of various packing types, and improve the workability during application with a spray, a brush, a roller, a combing trowel, or the like, the component (B) as a diluent is added to the moisture-curable composition of the present invention. The component (B) is a component capable of functioning as an agent for adjusting physical properties such as tensile strength and elongation or an additive for improving flexibility and weather resistance of a cured product. The diluent may also be called as a plasticizer. The diluent (B) is commercially available as a product or may be prepared by common chemical processes. The diluent (B) may be a simple substance or a mixture of two or more kinds in combination.

In general, a thinner for a paint, such as toluene or xylene, is used for a paint, and an organic solvent such as a mineral spirit is used for a sealing material, an adhesive, or the like. In consideration of harmfulness to the environment and the human body, a risk of burning by ignition, and the like, use of these organic solvents is not preferable.

Examples of the diluent (B) may include phthalic acid esters (e.g., dioctyl phthalate, diisooctyl phthalate, and diundecyl phthalate), perhydrogenated phthalic acid esters (e.g., 1,2-cyclohexanedicarboxylic acid diisononyl ester and 1,2-cyclohexanedicarboxylic acid dioctyl ester), non-phthalic acid-based plasticizers, adipic acid esters (e.g., dioctyl adipate), benzoic acid esters, glycol esters, esters of saturated alkanediols (e.g., 2,2,4-trimethyl-1,3-pentanediol monoisobutyrate and 2,2,4-trimethyl-1,3-pentanediol diisobutyrate), phosphoric acid esters, sulfonic acid esters, polyesters, polyethers (e.g., polyethylene glycols and polypropylene glycols having Mn of preferably 1,000 to 10,000), polystyrene, polybutadiene, polyisobutylene, paraffin hydrocarbons and branched hydrocarbons having macromolecular mass.

In particular, in a case of a reactive diluent, the diluent is a component capable of functioning as an agent for adjusting physical properties such as tensile strength and elongation or an additive for improving flexibility and weather resistance of a cured product due to incorporation in a network of the silane-terminated modified polymer or an interaction with the silane-terminated modified polymer.

The component (B) as the diluent is particularly preferably a reactive diluent containing an alkoxy group or the like. After curing, the reactive diluent is bonded to the polymer component and incorporated in a polymer matrix, as compared with a non-reactive diluent. Therefore, shrinkage of a cured product can be decreased, and mechanical physical properties, weather resistance, and durability can be improved.

A diluent containing a hydrophobic moiety and a hydrophilic moiety and having a viscosity range of higher than 10 mPa·s is preferable. Specifically, a polyether (for example, preferably a polyethylene glycol and a polypropylene glycol that have a molar mass of 300 to 10,000 and may or may not be branched), a silicone resin obtained by hydrolysis and polymerization of various kinds of alkoxysilane, and the like are preferable. A mixture thereof may also be used.

When the diluent more preferably has a viscosity range of higher than 10 mPa·s, the diluent is considered to have an effect of increasing the viscosity at a low shear rate. The diluent has a hydrophobic moiety and a hydrophilic moiety, a hydrophobized silica effectively forms a network through a Van der Waals force with respect to the hydrophobic moiety, and an amide wax effectively forms a network through a hydrogen bond with the hydrophilic moiety, an interaction with a hydrophilic moiety of various components, or the like.

Examples of the abovementioned diluent (B) silicone resin may typically contain a unit represented by the following general formula (4)

R³(R⁴O)_{d}R⁵ₑSiO_{(4-c-d-e)/2} (4)

(In the formula,

R³ may be the same or different and is a hydrogen atom, a monovalent, SiC-bonded and optionally substituted aliphatic hydrocarbon group, or a divalent, optionally substituted aliphatic hydrocarbon group that crosslinks two units represented by the formula (4),

R⁴ may be the same or different and is a methyl group or an ethyl group,

R⁵ may be the same or different and is a monovalent, SiC-bonded and optionally substituted aromatic hydrocarbon group,

c is 0, 1, 2, or 3,

d is 0, 1, 2, 3, or 4, and

e is 0, 1, or 2.)

Examples of the group R³ may include the aliphatic examples specified above for R. The group R³, however, may also include a divalent aliphatic group, e.g., an alkylene group having 1 to 10 carbon atoms, e.g., a methylene group, an ethylene group, a propylene group, or a butylene group, which links the two silyl groups of the formula (4) to each other. One particular example of the divalent aliphatic group at present is an ethylene group.

However, the group R³ preferably includes a monovalent, SiC-bonded, aliphatic hydrocarbon atom group which is optionally substituted by a halogen atom and has 1 to 18 carbon atoms, more preferably an aliphatic hydrocarbon group having 1 to 8 carbon atoms, and more particularly a methyl group.

Examples of the group R⁴ may include a hydrogen atom and the examples specified for the group R.

The group R⁴ includes a hydrogen atom or an alkyl group which is optionally substituted by a halogen atom and has 1 to 10 carbon atoms, more preferably an alkyl group having 1 to 4 carbon atoms, and more particularly a methyl group or an ethyl group.

Examples of the group R⁵ may include the aromatic groups specified above for R.

The group R⁵ preferably includes an SiC-bonded aromatic hydrocarbon group which is optionally substituted by a halogen atom and has 1 to 18 carbon atoms, e.g., an ethylphenyl group, a tolyl group, a xylyl group, a chlorophenyl group, a naphthyl group or a styryl group, and more preferably a phenyl group.

Preferably used as the component (B) is a silicone resin in which at least 90% of all the group R³ are a methyl group, at least 90% of all the group R⁴ are a methyl group, an ethyl group, a propyl group, or an isopropyl group, and at least 90% of all the group R⁵ are a phenyl group.

According to the present invention, preference is given to using, in each case, a silicone resin having the unit of the formula (2), in which c is 0, in an amount of at least 20%, more preferably at least 40%, relative to the total number of units of the formula (2).

In one embodiment of the present invention, in each case, used is a silicone resin having the unit of the formula (2), in which c is a value of 2, in an amount of at least 10%, more preferably at least 20%, and equal to or less than 80%, more preferably equal to or less than 60% relative to the total number of units of the formula (2).

More preferentially used silicone resin is, in each case, a silicone resin having the unit of the formula (2), in which d represents a value of 0 or 1, in an amount of at least 80%, preferably at least 95%, relative to the total number of units of the formula (2).

It is preferential to use, in each case, a silicone resin having the unit of the formula (2), in which d represents a value of 0, in an amount of at least 60%, more preferably at least 70%, and preferably equal to or less than 99%, more preferably equal to or less than 97%, relative to the total number of units of the formula (2).

As the diluent (B), in each case, a silicone resin having the unit of the formula (4), in which e is a value other than 0, in an amount of at least 1%, preferably at least 10%, and more particularly at least 20%, relative to the total number of units of the formula (4) is more preferentially used. A silicone resin having only the unit of the formula (4) in which e is a value other than 0 may be used, but in more preferably at least 10%, and very preferably at least 20%, and preferably 80% or less, and more preferably 60% or less of the unit of the formula (4), e is 0.

As the diluent (B), a silicone resin having the unit of the formula (4), in which e is a value of 1, in an amount of at least 20%, and more preferably at least 40%, relative to the total number of the units of the formula (4) is preferentially used. A silicone resin having only the unit of the formula (4) in which e is 1 may be used, but in more preferably at least 10%, and very preferably at least 20%, and preferably 80% or less, and more preferably 60% or less of the unit of the formula (4), e is 0.

A silicone resin having at least 50% of the unit of the formula (4), in which a sum c+e is 0 or 1, relative to the total number of the units of the formula (4) is preferentially used.

In a particularly preferable embodiment of the present invention, a silicone resin having at least 20%, and more preferably at least 40% of the unit of the formula (4), in which e is 1 and c is 0, relative to the total number of the units of the formula (4) is used as a base surface-adjusting agent. In this case, in preferably 70% or less, and more preferably 40% or less of all the units of the formula (4), d is a value other than 0.

In another particularly preferable embodiment of the present invention, a silicone resin used as the diluent is a resin having the unit of the formula (4), in which e is a value of 1 and c is a value of 0, in an amount of at least 20%, and more preferably at least 40% relative to the total number of the units of the formula (4), and further having the unit of the formula (4), in which c is 1 or 2, and preferably 2, and e is 0, in an amount of at least 1%, and preferably at least 10% relative to the total number of the units of the formula (4). In this case, in preferably 70% or less, and more preferably 40% or less of all the units of the formula (4), d is a value other than 0, and in at least 1% of all the units of the formula (4), d is 0.

Examples of the silicone resins used in accordance with the present invention may substantially, preferably exclusively, include organopolysiloxane resins including units represented by the formula (Q) of SiO_{4/2}, Si(OR¹¹)O_{3/2}, Si(OR¹¹)₂O_{2/2}, and Si(OR¹¹)₃O_{1/2}, units represented by the formula (T) of PhSiO_{3/2}, PhSi(OR¹¹)O_{2/2}, and PhSi(OR¹¹)₂O_{1/2}, units represented by the formula (D) of Me₂SiO_{2/2} and Me₂Si(OR¹¹)O_{1/2}, and units represented by the formula (M) of Me₃SiO_{1/2} (in the formula, Me is a methyl group, Ph is a phenyl group, R¹¹ is a hydrogen atom or an alkyl group optionally substituted with a halogen atom and having 1 to 10 carbon atoms, more preferably a hydrogen atom or an alkyl group having 1 to 4 carbon atoms). The resin preferably includes 0 to 2 mol of the (Q) unit, 0 to 2 mol of the (D) unit, and 0 to 2 mol of the (M) unit per mole of the (T) unit.

Preferable examples of the silicone resins used in accordance with the present invention may substantially, preferably exclusively, include organopolysiloxane resins including a T unit of PhSiO_{3/2}, PhSi(OR¹¹)O_{2/2}, and PhSi(OR¹¹)₂O_{1/2}, and/or a (D) unit of Me₂SiO_{2/2} and Me₂Si(OR¹¹)O_{1/2} (in the formula, Me is a methyl group, Ph is a phenyl group, R¹¹ is a hydrogen atom or an alkyl group optionally substituted with a halogen atom and having 1 to 10 carbon atoms, more preferably a hydrogen atom or an alkyl group having 1 to 4 carbon atoms, and a molar ratio of the (T) unit to the (D) unit is 0.5:2.0).

More preferable examples of the silicone resins used in accordance with the present invention may substantially, preferably exclusively, include organopolysiloxane resins including a T unit of PhSiO_{3/2}, PhSi(OR¹¹)O_{2/2}, and PhSi(OR¹¹)₂O_{1/2}, a T unit of MeSiO_{3/2}, MeSi(OR¹¹)O_{2/2}, and MeSi(OR¹¹)₂O_{1/2}, and, as needed, a (D) unit of Me₂SiO_{2/2} and Me₂Si(OR¹¹)O_{1/2} (in the formula, Me is a methyl group, Ph is a phenyl group, R¹¹ is a hydrogen atom or an alkyl group optionally substituted with a halogen atom and having 1 to 10 carbon atoms, more preferably a hydrogen atom or an alkyl group having 1 to 4 carbon atoms, and a molar ratio of a phenyl silicone unit to a methyl silicone unit is 0.5:4.0). The amount of the D units in the silicone resin is preferably less than 10% by weight.

More preferable examples of the silicone resins used in accordance with the present invention may substantially, preferably exclusively, include organopolysiloxane resins including a T unit of PhSiO_{3/2}, PhSi(OR¹¹)O_{2/2}, and PhSi(OR¹¹)₂O_{1/2} (in the formula, Ph is a phenyl group, R¹¹ is a hydrogen atom or an alkyl group optionally substituted with a halogen atom and having 1 to 10 carbon atoms, more preferably a hydrogen atom or an alkyl group having 1 to 4 carbon atoms). The amount of the D units in the silicone resin is preferably less than 10% by weight.

The silicone resin used in accordance with the present invention preferably has Mn (number average molecular weight) of at least 400, more preferably at least 600. This Mn is preferably 400,000 or less, more preferably 10,000 or less, and more specifically 50,000 or less.

The silicone resin used in accordance with the present invention may be either solid or liquid at 23° C. and 1,000 hPa, and the silicone resin is preferably liquid. This silicone resin preferably has a viscosity of 10 to 100,000 mPa·s, preferably 30 to 50,000 mPa·s, and more specifically 50 to 1,000 mPa·s. The smaller the viscosity of the silicone resin is, the lower the viscosity at a high shear rate is, and the better the workability is. This silicone resin has a polydispersity (Mw/Mn) of preferably 5 or less, more preferably 3 or less. Herein, Mw represents the weight average.

The hydrophobized inorganic particles (C) impart a certain degree of thixotropic properties by forming a network in the system by their Van der Waals force to thicken the whole system with respect to the moisture-curable composition of the present invention.

In particular, the hydrophobized silica is considered to effectively form a network for the hydrophobic moieties of the silane-terminated modified polymer and the diluent.

Examples of the inorganic particles used as raw materials for the hydrophobized inorganic particles (C) may include silica, titanium dioxide, bentonite, zinc oxide, talc, kaolin, mica, vermiculite, magnesium carbonate, calcium carbonate, aluminum silicate, barium silicate, calcium silicate, magnesium silicate, strontium silicate, tungsten acid metal salts, magnesium, zeolite, barium sulfate, calcined calcium sulfate, calcium phosphate, fluoroapatite, hydroxyapatite, metal soaps, and the like metal particles.

Further, composite particles obtained by coating particles with a metal oxide or the like, or modified particles whose surfaces are treated with a compound or the like may be used.

Usually, on the surface of these particles, there are a moiety covered with a hydrophilic group such as a silanol group, a carbinol group, or another hydroxyl group, and a moiety covered with a group obtained by hydrophobizing the forgoing groups with an alkyl group or the like, or another hydrophobic group.

By adjusting the ratio of the hydrophilic group to the hydrophobic group, the cohesiveness and solubility of the inorganic particles in the system can be controlled.

Among the inorganic particles, silica is preferably used. Silica includes fumed silica, wet silica, and colloidal silica. On a surface of particles of any silica, a silanol that is hydrophilic exists, and a silanol group thereof can be subjected to a hydrophobic treatment with an alkyl group or the like at any ratio. Therefore, the molar ratio of a hydrophilic group and a hydrophobic group on the surface is easily set. From the viewpoint of use of an aggregated structure, high affinity with various kinds of oil, availability, and cost efficiency, silica is preferable. This is because a wide use application is made possible.

In the present invention, the most preferably used silica is fumed silica.

Fumed silica particles have a multidimensionally aggregated structure. Therefore, a balance between the hydrophilic group and the hydrophobic group on the surface can be controlled according to an aggregation level, and aggregation units can be recombined.

Since the fumed silica particles have a porous structure, the surface area is large, and functions of association and adsorption are enhanced. Therefore, a system can be more stably and uniformly produced.

In the fumed silica particles, primary particles, which are the smallest unit, generally have a size of about 5 to 30 nm. The primary particles are aggregated to form primary aggregates, that is, secondary particles. The size of the primary aggregates is generally about 100 to 400 nm. Since the primary particles are fused through a chemical bond, it is generally difficult to separate the primary aggregates. From the primary aggregates, an aggregated structure is formed, which is called secondary aggregate, that is, tertiary particle. The size of secondary aggregates is about 10 μm. An aggregation form between the primary aggregates in the secondary aggregates is generally derived not by a chemical bond but by a hydrogen bond and a Van der Waals force.

When the fumed silica particles are in a powder shape, the secondary aggregates are often in the largest aggregation state. However, the secondary aggregates can be further aggregated in the moisture-curable composition. That is, in one example of the present invention, the hydrophobized silica effectively forms a network with respect to the hydrophobic moieties of the silane-terminated modified polymer and the diluent through a Van der Waals force. A force for separating such aggregation is less than a force of separating the secondary aggregates. That is, in one example of the present invention, when the moisture-curable composition is applied with a combing trowel or the like, the aggregation is separated to decrease the viscosity during action.

It is preferable that the fumed silica particles be hydrophobic. A component used in hydrophobization is not particularly limited. For example, the component used in hydrophobization can be made hydrophobic by a known method such as treatment with a halogenated organic silicon such as methyltrichlorosilane, an alkoxysilane such as dimethyldialkoxysilane, silazane, or a low-molecular-weight methylpolysiloxane.

The content of the hydrophobized inorganic particles (C) in the whole composition is desirably 0.1 to 20 parts by mass. When the content exceeds 20 parts by mass, the viscosity of the whole system is increased, the system may be made ununiform due to insufficient stirring during production of the moisture-curable composition, and the workability during application may be significantly decreased. It is more preferably within a range of 1 to 10 parts by mass, and further preferably within a range of 2 to 5 parts by mass.

Examples of the component (D) as a thixotropic agent having a hydrophobic moiety and a hydrophilic moiety may include a hydrogenated castor oil-based agent, an amide-based agent, a polyethylene oxide-based agent, a vegetable oil polymerized oil-based agent, and a surfactant-based agent, and the component (D) may be a single component or two or more kinds of these in combination.

Herein, the hydrophobic moiety of the thixotropic agent is not particularly limited as long as it contains a hydrophobic group or a bond having a locally small polarity, and examples thereof may include an alkyl group, a phenyl group, a C—C bond in a polyether chain, and a polydimethylsiloxane.

On the other hand, the hydrophilic moiety thereof is not particularly limited as long as it contains a hydrophilic group or a bond having a locally large polarity, and examples thereof may include a hydroxyl group, an alkoxy group, a polyether bond, an ester bond, a urethane bond, and an amide bond.

For example, an amido wax has a carbon-carbon moiety as a hydrophobic moiety and an amide group as a hydrophilic moiety.

In the moisture-curable composition of the present invention, the thixotropic agent (D) forms a network through an interaction between the hydrophilic moieties thereof, in particular, in a case of the presence of a hydroxyl group or an amide bond, through a hydrogen bond thereof and an interaction with the hydrophilic moieties of various components, so that the viscosity of the system is increased.

The thixotropic agent (D) is particularly preferably an amide wax. In this case, the thixotropic agent has a particle size smaller than the hydrophobized silica and has a needle shape. Therefore, a sparse network is formed in the system and the viscosity of the whole system is moderately increased. Accordingly, the thixotropic agent has characteristics of no large contribution to viscosity at a high shear rate and large contribution to viscosity at a low shear rate.

It is considered that the amide wax effectively forms a network with respect to the hydrophilic moieties of the silane-terminated modified polymer and the diluent.

The amine compound (E) is a component that has a function of a curing catalyst or a curing cocatalyst for the moisture-curable composition of the present invention and can function as an adhesion promoter.

The structure and molecular weight of the amine compound (E) are not particularly limited, and the amine compound (E) is commercially available as a product or may be prepared by common chemical processes.

The amine compound (E) may be a simple substance or a mixture of two or more kinds in combination.

The amine compound (E) may be, for example, an organosilicon compound containing the unit of the general formula (5). An aminopropyltrimethoxysilyl group is mentioned as an example of the unit of the general formula (5).

DₕSi(OR⁶)_{g}R⁷_{f}O_{(4-f-g-h)/2} (5)

(In the formula, R⁶ may be the same or different, and is a hydrogen atom or an optionally substituted hydrocarbon group,

D may be the same or different and is a monovalent SiC-boned group containing basic nitrogen,

R⁷ may be the same or different and is a monovalent SiC-bonded organic group optionally substituted if it does not contain basic nitrogen,

f is 0, 1, 2, or 3, preferably 1 or 0,

g is 0, 1, 2, or 3, preferably 1, 2, or 3, more preferably 2 or 3,

h is 1, 2, 3, or 4, preferably 1, but the total of f+g+h is 4 or less, and there is at least one group D per molecule.)

The amine compound (E) can include not only silane, that is, the compound of the general formula (5) where f+g+h=4, but also siloxane, that is, the unit of the formula (5) where f+g+h≤3. Silane is preferentially used.

The content of the amine compound (E) in the whole composition is preferably in the range of 0.01 to 10 parts by mass.

When the content of the amine compound (E) is less than 0.01 parts by mass, poor curing and/or poor adhesion may be caused. When the content exceeds 10 parts by mass, an unnecessary reaction may be caused, adverse influences such as wrinkling on a surface of a film and modification of a material around a coating film after formation of the coating film may be caused, or the use time may be shortened, resulting in poor application. Furthermore, troubles such as an increase in viscosity, gelation, and curing may be caused due to storage stability. It is more preferably within a range of 0.5 to 3.0 parts by mass.

The dehydrating agent (F) is a component that dehydrates the moisture-curable composition of the present invention by water trapping.

The dehydrating agent (F) is commercially available as a product or may be prepared by common chemical processes. The component (F) may be a simple substance or a mixture of two or more kinds in combination.

Examples of the component (F) may include silanes, e.g., vinyltrimethoxysilane, vinyltriethoxysilane, vinylmethyldimethoxysilane, O-methylcarbamatemethyl-methyldimethoxysilane, O-methylcarbamatemethyl-trimethoxysilane, O-ethylcarbamatemethyl-methyldiethoxysilane, O-ethylcarbamatemethyl-triethoxysilane, and partial condensates thereof, and orthoesters, e.g., 1,1,1-trimethoxyethane, 1,1,1-triethoxyethane, trimethoxymethane, and triethoxymethane.

The content of the dehydrating agent (F) in the whole composition is preferably within a range of 0.01 to 10 parts by mass, but may not be contained. When the content is less than 0.01 parts by mass, a dehydration effect is insufficient, and troubles such as an increase in viscosity, gelation, and curing may be caused during production and storage. When the content exceeds 10 parts by mass, troubles such as deterioration of physical properties of the coating film may be caused, and poor curing or uncuring may be caused after application. It is more preferably within a range of 0.5 to 3.0 parts by mass.

The stabilizer (G) is a component that has a function of an ultraviolet absorber, an antioxidant, a thermal stabilizer, or a light stabilizer for the moisture-curable composition of the present invention, and can function as a stabilizer against deterioration of a polymer.

The stabilizer (G) is commercially available as a product or may be prepared by common chemical processes.

The stabilizer (G) may be a simple substance or a mixture of two or more kinds in combination.

The stabilizer (G) is not limited as long as it exhibits the above-mentioned functions and actions, and, but is preferably an antioxidant, an ultraviolet stabilizer, and a HALS.

The content of the stabilizer (G) in the whole composition is preferably within a range of 0.01 to 5 parts by mass. When the content is less than 0.01 parts by mass, the coating film may be deteriorated by ultraviolet light, heat, oxidation, or the like. When the content exceeds 5 parts by mass, an unexpected trouble may be caused, for example, color in a transparent product may be changed. It is more preferably within a range of 0.5 to 2.0 parts by mass.

The filler (H) is a component that has a function of an extender, adjustment of viscosity or tacking, and adjustment of physical properties such as tensile strength and elongation, and can function as a curing accelerator for a coating material by contained moisture. When the aforementioned function and action are unnecessary, this component is not an essential component for a coating material composition of the present invention.

The filler (H) is commercially available as a product or may be prepared by common chemical processes.

The filler (H) may be a simple substance or a mixture of two or more kinds in combination.

The filler (H) is not limited as long as it exhibits the foregoing functions and actions. Examples of the filler (H) may include a non-reinforcing filler, and preferably a filler having a BET surface area of up to 50 m²/g, e.g., quartz, silica sand, diatomaceous earth, calcium silicate, zirconium silicate, talc, kaolin, and zeolite, a powder of metal oxide including aluminum oxide, titanium oxide, iron oxide, or zinc oxide, and/or mixed oxides thereof, barium sulfate, calcium carbonate, gypsum, silicon nitride, silicon carbide, boron nitride, a glass powder, and a polymer powder, e.g., a polyacrylonitrile powder; a reinforcing filler, and a filler having a BET surface area exceeding 50 m²/g, e.g., silica prepared by pyrolyzed, precipitated silica, precipitated calcium carbonate, carbon black, e.g., furnace black, and acetylene black, and mixed silicon/aluminum oxides having high BET surface area; a filler in the form of a hollow bead of aluminum trihydroxide, e.g., magnetic microbeads that are exemplified by a product available as trade name Zeeospheres (trademark) from 3M Deutschland GmbH of Neuss, Germany, elastic polymeric beads of this kind, available as trade name EXPANCEL (registered trademark) from AKZONOBEL, Expancel, Sundsvall, Sweden, or glass beads; and a filler in a fiber form, e.g., asbestos and/or polymeric fillers. For example, the aforementioned fillers may be hydrophobized by a treatment with organosilane and/or organosiloxane or with stearic acid or by etherification of a hydroxyl group to an alkoxy group.

The filler (H) is preferably calcium carbonate, talc, aluminum hydroxide or silica, with aluminum hydroxide being particularly preferable. The preferable grade of calcium carbonate is ground or precipitated one and is optionally surface treated with a fatty acid such as stearic acid or a salt thereof. The preferable silica is pyrolyzed (fumed) silica.

The filler (H) preferably has a water content of less than 1 part by mass, more preferably less than 0.5 parts by mass.

The content of the filler (H) in the whole composition is preferably within a range of 0 to 80 parts by mass, and more preferably within a range of 0 to 60 parts by mass. When the content is within the aforementioned range, defects of the coating material such as poor adhesion and cracking of the film are hardly caused, and the viscosity during production is suitable. Therefore, uniform stirring can be achieved.

The catalyst (I) is a component having a function of a curing catalyst for the moisture-curable composition of the present invention. When the aforementioned function and action are unnecessary, this component is not an essential component for the moisture-curable composition of the present invention. When the reactivity of the silane-terminated modified polymer (A) is low, the catalyst (I) is an effective component.

The catalyst (I) is commercially available as a product or may be prepared by common chemical processes.

The catalyst (I) may be a simple substance or a mixture of two or more kinds in combination.

The catalyst (I) is not limited as long as it exhibits the foregoing functions and actions. Examples of the component (E) containing metal may include organotitanium and organotin compounds. Examples thereof may include titanate esters e.g., tetrabutyl titanate, tetrapropyl titanate, tetraisopropyl titanate, and titanium tetraacetylacetonate; and tin compounds, e.g., dibutyltin dilaurate, dibutyltin maleate, dibutyltin diacetate, dibutyltin dioctanoate, dibutyltin acetylacetonate, and dibutyltin oxide, and dioctyltin compounds corresponding to these.

Examples of the catalysts (E) containing no metal may include basic compounds, e.g., triethylamine, tributylamine, 1,4-diazabicyclo[2.2.2]octane, 1,5-diazabicyclo[4.3.0]non-5-ene, 1,8-diazabicyclo[5.4.0]undeca-7-ene, N,N-bis-(N,N-dimethyl-2-aminoethyl)methylamine, N,N-dimethylcyclohexylamine, N,N-dimethylphenylamine, and N-ethylmorpholinine(ethylmorpholinine).

As the catalyst (I), it is also possible to use acidic compounds, e.g., phosphoric acid and esters thereof, toluenesulfonic acid, sulfuric acid, nitric acid, or other organic carboxylic acids, e.g., acetic acid and benzoic acid.

The content of the catalyst (I) in the whole composition is preferably within a range of 0 to 5 parts by mass. When the content exceeds 5 parts by mass, the use time may be decreased to cause poor application, the surface of the film may be wrinkled, or troubles such as an increase in viscosity, gelation, and curing may be caused during storage. The content is more preferably within a range of 0 to 0.2 parts by mass.

In addition to the aforementioned components, the moisture-curable composition of the present invention may contain an optional component as long as the object of the present invention is achieved. For example, the moisture-curable composition may contain all other substances such as a defoaming agent, a curing rate-adjusting material, an additive, an adhesion enhancer, and an auxiliary agent. A component for improving adhesion, for example, epoxysilane may be optionally added.

The present invention is also a method for producing a moisture-curable composition including an amide wax kneading step of adding the silane-terminated modified polymer (A) to an amide wax content, and kneading the mixture, and an inorganic particle kneading step of mixing the diluent with the amide wax-containing mixture obtained in the amide wax kneading step, to decrease the viscosity thereof, so as to improve the stirring efficiency when hydrophobized inorganic particles and the filler to be mixed are stirred.

In the amide wax kneading step, the amide wax may be kneaded without heating or after heating. In a case of kneading the amide wax without heating, the amide wax is kneaded at temperature during storage (e.g., the temperature may be, in winter, about 0 to 20° C., and in summer, 20 to 40° C.). In a case of kneading the amide wax after heating, the amide wax may be heated to a temperature of 30° C. or higher and 100° C. or lower, and preferably 50° C. or higher and 90° C. or lower.

Furthermore, the amide wax kneading step may include a first step of adding the silane-terminated modified polymer (A) in an amount of 1 to 2 times the amide wax content, and adjusting the mixed amide wax masterbatch, and a second step of mixing the rest of the silane-terminated modified polymer (A) to the amide wax masterbatch to obtain an amide wax-containing mixture. The method for producing a moisture-curable composition is characterized by the first and second steps to efficiently knead a diluent having a low viscosity to be added later and the amide wax-containing mixture and improve the dispersibility of the amide wax.

A substrate to which the moisture-curable composition of the present invention is applied is not particularly limited, and may or may not be porous. Examples of the substrate may include a cement-based substrate, a mineral substrate, a metal, a glass, and a ceramic. The substrate having a coated surface may be used.

Examples of the cement-based substrate may include concrete, a mortar siding board, a light-weight foam concrete (ALC), a slate board, and a calcium silicate board.

Various use applications to which the moisture-curable composition of the present invention can be applied are conceivable, and the use application is not limited. Examples thereof may include a building construction, an adhesive and a sealing material for a vehicle, a ship, and a building construction, a floor material for a factory and an architecture, concrete falling prevention of a freeway and an elevated railroad, a paint for architecture finishing, a coating-film water-proof material of a board and a roof, and various concrete secondary products.

### EXAMPLES

Results are shown in Table 1, and the present invention will be specifically described with reference to Examples and Comparative Examples. However, the present invention is not limited to the following Examples.

### <Measurement of Viscosity of Moisture-Curable Composition>

Values at a high shear rate (10 (1/s)) and a low shear rate (2 (1/s)) after 60 seconds were measured as viscosities at the shear rates with a viscoelasticity measurement device (Physica MCR 301 manufactured by Anton Paar GmbH).

### <Criteria for Evaluation of Viscosity>

A viscosity at a high shear rate (10 (1/s)) of higher than 100×10³ mPa·s represents good workability.

A viscosity at a low shear rate (2 (1/s)) of lower than 250×10³ mPa·s represents good ceramic tile-shifting property.

<Evaluation of Workability with Combing Trowel>

About 200 g of a moisture-curable composition of each of Examples 1 to 4 and Comparative Examples 1 to 5 was uniformly applied to a slate board (3 mm×300 mm×300 mm) with a combing trowel having a pitch of 0.5 mm, and plastering workability was evaluated.

<Criteria for Evaluation of Workability with Combing Trowel>

A lighter load in workability is preferable. In A and B, the workability is good.

A: Very light load
B: Light load
C: Heavy load

### <Evaluation of Ceramic Tile-Shifting Property>

About 200 g of a moisture-curable composition of each of Examples 1 to 4 and Comparative Examples 1 to 5 was uniformly applied to a slate board (3 mm×300 mm×300 mm) with a combing trowel having a pitch of 0.5 mm. A ceramic tile called nichogake (about 260 g) was attached and fixed with about 2.5 kg of weight disposed on the ceramic tile for 30 seconds. The slate board was kept vertically, and the shifting property of the ceramic tile was evaluated.

### <Criteria for Evaluation of Ceramic Tile-Shifting Property>

For shifting property, no shift is required. In A, the shifting property is good.

A: Shift does not occur.
B: Shift occurs.

### Example 1

For a moisture-curable composition, the following components were used.

1.50 Parts by mass of an amide wax A-S-A (registered trademark) T-1700 available from Itoh Oil Chemicals Co., Ltd., as the thixotropic agent (D), and 3.00 parts by weight of GENIOSIL (registered trademark) STP-E10 (average molar mass (Mₙ): 12,000 g/mol) available from Wacker Chemie AG heated to 90° C. as the silane-terminated modified polymer (A) were added, mixed, and uniformly kneaded.

GENIOSIL (registered trademark) STP-10 was a silane-terminated polypropylene glycol having an end group of —O—C(═O)—NH—CH₂—SiCH₃(OCH₃)₂ as a hydrophobic moiety, and a main chain of a polypropylene glycol chain as a hydrophobic moiety.

5.75 Parts by mass of remaining GENIOSIL (registered trademark) STP-E10 heated to 90° C. was further added, mixed, and uniformly kneaded.

39.25 Parts by mass of GENIOSIL (registered trademark) IC 368 available from Wacker Chemie AG as the diluent (B) was added and uniformly stirred.

GENIOSIL (registered trademark) IC 368 was a liquid phenylsilicone resin including a phenyl functional T unit and a methyl functional T unit, and having a viscosity of 336 mPa·s, a methoxy group content of 15% by weight, and an average molar mass of 1,900 g/mol.

2.00 Parts by mass of GENIOSIL (registered trademark) XL10 (vinyltrimethoxysilane) available from Wacker Chemie AG as the vinyl silane-based dehydrating agent (F), 1.00 part by mass of Tinuvin B 75 available from BASF as the stabilizer (G), 2.00 parts by mass of GENIOSIL (registered trademark) GF80 (3-glycidoxypropyltrimethoxysilane) available from Wacker Chemie AG as an adhesion enhancer, and 1.20 parts by mass of WACKER (registered trademark) TES 40 (oligomer of tetraethoxysilane) available from Wacker Chemie AG as a curing rate-adjusting agent were added and uniformly stirred.

3.00 Parts by mass of hydrophobized silica HDK (registered trademark) H18 available from the same company as the hydrophobized inorganic particles (C), 21.80 parts by mass of Viscolite-EL20 available from Shiraishi Kogyo Kaisha, Ltd., as synthesis calcium carbonate that was a filler as the component (H), and 20.00 g of SOFTON 2200 available from Shiraishi Kogyo Kaisha, Ltd., as a surface-untreated heavy-weight calcium carbonate were added and uniformly stirred.

As the amine compound (E), 1.00 part by mass of GENIOSIL (registered trademark) GF96 (3-aminopropyltrimethoxysilane) available from Wacker Chemie AG was further added and uniformly stirred to prepare the moisture-curable composition.

From the measurement result of viscosity, the workability and the ceramic tile-shifting property were good.

The workability with a combing trowel was good and the ceramic tile-shifting property was good.

### Example 2

The same evaluations were performed using the same components, the same number of parts by mass, and the same preparation method as those of Example 1 except that polypropylene glycol (viscosity 60 to 80mPa·s) available from FUJIFILM Wako Pure Chemical Corporation, diol type, (average molecular weight of about 400) were used in an amount of 39.25 parts by mass as the diluent (B).

From the measurement result of viscosity, the workability and the ceramic tile-shifting property were good.

The workability with a combing trowel was good and the ceramic tile-shifting property was good.

### Example 3

The same evaluations were performed using the same components, the same number of parts by mass, and the same preparation method as those of Example 1 except that GENIOSIL (registered trademark) IC 678 available from the same company was used in an amount of 39.25 parts by mass of as the diluent (B).

GENIOSIL (registered trademark) IC 678 is a liquid phenylsilicone resin having a viscosity of 73 mPa·s, consisting only of a phenyl functional T unit, and having a methoxy group content of 15% by weight and an average molar mass of 900 g/mol.

From the measurement result of viscosity, the workability and the ceramic tile-shifting property were good.

The workability with a combing trowel was good and the ceramic tile-shifting property was good.

### Example 4

The same evaluations were performed using the same components, the same number of parts by mass, and the same preparation method as those of Example 1 except that, as the silane-terminated modified polymer (A), a polymer having the same chemical structure as that of GENIOSIL (registered trademark) STP-E10 available from Wacker Chemie AG and having an average molar mass (Mn) of 4,000 g/mol was used in an amount of 8.75 parts by mass.

From the measurement result of viscosity, the workability and the ceramic tile-shifting property were good.

The workability with a combing trowel was good and the ceramic tile-shifting property was good.

### Comparative Example 1

8.75 Parts by weight of GENIOSIL (registered trademark) STP-E10 available from Wacker Chemie AG at room temperature (20° C.) as the silane-terminated modified polymer (A), and 16.25 parts by mass of polypropylene glycol available from FUJIFILM Wako Pure Chemical Corporation, diol type, (average molecular weight of about 400) and 23.00 parts by mass of GENIOSIL (registered trademark) IC 368 available from Wacker Chemie AG as the diluents (B) were added and stirred uniformly. After that, the same evaluations were performed using the same components, the same number of parts by mass, and the same preparation method as those of Example 1.

From the measurement result of viscosity, the workability was good, but the ceramic tile-shifting property was lower than the reference value.

The workability with a combing trowel was good, but for the ceramic tile-shifting property, shift occurred.

In Comparative Example 1, it is conceivable that no increase in viscosity at a low shear rate was confirmed because a thixotropic agent having a hydrophobic moiety and a hydrophilic moiety was not mixed.

### Comparative Example 2

1.50 Parts by mass of A-S-A (registered trademark) T-1700 available from Itoh Oil Chemicals Co., Ltd., as the thixotropic agent (D), and 3.00 parts by weight of GENIOSIL (registered trademark) STP-E10 (average molar mass (Mn): 12,000 g/mol) available from Wacker Chemie AG heated to 90° C. as the silane-terminated modified polymer (A) were added, mixed, and uniformly kneaded. 5.75 Parts by mass of remaining GENIOSIL (registered trademark) STP-E10 heated to 90° C. was further added, mixed, and uniformly kneaded. 39.25 Parts by mass of WACKER (registered trademark) AK350 available from Wacker Chemie AG as the diluent (B) was added and stirred. However, the mixture did not become uniform and was separated. Therefore, measurement of viscosity, evaluation of workability with a combing trowel, and evaluation of ceramic tile-shifting property could not be performed.

WACKER (registered trademark) AK350 was a linear polydimethylsiloxane having only a hydrophobic moiety. It is conceivable that due to the absence of hydrophilic moiety, the actions with the polymer and the thixotropic agent were insufficient and separation occurred.

### Comparative Example 3

The same evaluations were performed using the same components, the same number of parts by mass, and the same preparation method as those of Example 1 except that SILRES (registered trademark) BS (isooctyltrimethoxysilane having a viscosity of 1316 2 mPa·s was used in an amount of 39.25 parts by mass as the diluent (B).

From the measurement result of viscosity, the workability was good, but the ceramic tile-shifting property was lower than the reference value.

The workability with a combing trowel was good, but for the ceramic tile-shifting property, shift occurred.

The viscosity of BS 1316 mixed as the diluent was lower than 10 mPa·s. Therefore, the viscosities of the whole moisture-curable composition at a low shear rate and a high shear rate were low. It is conceivable that due to low viscosity at a high shear rate, the workability was good, but the viscosity at a low shear rate was not sufficiently increased, resulting in the occurrence of shift.

### Comparative Example 4

The same evaluations were performed using the same components, the same number of parts by mass, and the same preparation method as those of Example 1 except that 39.25 parts by mass of n-hexane available from Kanto Chemical Co., Inc. was used as the diluent (B).

The viscosity of n-hexane is 0.3 mPa·s.

From the measurement result of viscosity, the workability was good, but the ceramic tile-shifting property was lower than the reference value.

For workability with a combing trowel, after the moisture-curable composition was cured, cracking occurred, and the tile was peeled from the substrate.

In Comparative Example 4, the viscosity of the diluent was lower than 10 mPa·s, like Comparative Example 3. Therefore, the viscosities of the whole moisture-curable composition at a low shear rate and a high shear rate were low. Due to low viscosity at a high shear rate, the workability was good. Due to low viscosity at a low shear rate, shift occurred.

n-hexane was a non-reactive diluent and had high volatility. Therefore, it is considered that the volume was shrunk due to volatilization of n-hexane immediately after coating, resulting in cracking.

### Comparative Example 5

1.50 Parts by mass of A-S-A (registered trademark) T-1700 available from Itoh Oil Chemicals Co., Ltd., as the thixotropic agent (D), and 3.00 parts by weight of GENIOSIL (registered trademark) STP-E10 (average molar mass (Mₙ): 12,000 g/mol) available from Wacker Chemie AG heated to 90° C. as the silane-terminated modified polymer (A) were added, mixed, and uniformly kneaded. Further, 5.75 parts by mass of GENIOSIL (registered trademark) STP-E10 heated to 90° C. was added and mixed, and the mixture was uniformly kneaded, and then 39.25 parts by mass of the remaining GENIOSIL (registered trademark) STP-E10 heated to 90° C. were added and mixed in 4 portions and stirred uniformly. No diluent was added.

After that, the same evaluations were performed using the same components, the same number of parts by mass, and the preparation methods as those in Example 1.

From the measurement result of viscosity, the ceramic tile-shifting property was good, but the workability was largely more than the reference value. Since a diluent was not mixed, it was considered that the viscosity at a high shear rate was not sufficiently decreased, and the workability was deteriorated.

The workability with a combing trowel was a heavy load, and the ceramic tile-shifting property was good.

TABLE 1

| | | | | | | | | Compar- |
|---|---|---|---|---|---|---|---|---|
| | | | | Exam- | Exam- | Exam- | Exam- | ative |
| Amount in Parts by Mass of Each Component | | | | ple 1 | ple 2 | ple 3 | ple 4 | Example 1 |
| Silane-Terminated Modified Polymer | | | GENIOSIL ® STP-E10 | 8.75 | 8.75 | 8.75 | | 8.75 |
| | | | (Mn = 12,000 g/Mol) | | | | | |
| | | | Silane-Terminated | | | | 8.75 | |
| | | | Modified Polymer | | | | | |
| | | | (Mn = 4,000 g/Mol) | | | | | |
| Surface-Treated Hydrophobized Silica | | | HDK H18 | 3.00 | 3.00 | 3.00 | 3.00 | 3.00 |
| Polyamide Wax | | | A-S-A ® T-1700 | 1.50 | 1.50 | 1.50 | 1.50 | |
| Diluent | High | Having Hydrophobic | GENIOSIL ® IC368 | 39.25 | | | 39.25 | |
| | Viscosity | Moiety and | Polypropylene Glycol | | 39.25 | | | 16.25 |
| | | Hydrophilic Moiety | GENIOSIL ® IC678 | | | 39.25 | | 23.00 |
| | | Having Only | WACKER ® AK 350 | | | | | |
| | | Hydrophobic Moiety | | | | | | |
| | Low | Having Hydrophobic | SILRES ® BS1316 | | | | | |
| | Viscosity | Moiety and | | | | | | |
| | | Hydrophilic Moiety | | | | | | |
| | | Having Only | n-Hexane | | | | | |
| | | Hydrophobic Moiety | | | | | | |

| Curing Rate-Adjusting Agent | | WACKER ® TES40 | 1.20 | 1.20 | 1.20 | 1.20 | 1.20 |
|---|---|---|---|---|---|---|---|
| Dehydrating Agent | | GENIOSIL ® XL10 | 2.00 | 2.00 | 2.00 | 2.00 | 2.00 |
| Adhesion Enhancer | | GENIOSIL ® GF80 | 2.00 | 2.00 | 2.00 | 2.00 | 2.00 |
| Stabilizer | | Tinuvin ® B75 | 1.00 | 1.00 | 1.00 | 1.00 | 1.00 |
| Synthesis Calcium Carbonate | | Viscolite-EL20 | 21.80 | 21.80 | 21.80 | 21.80 | 21.80 |
| Surface-Untreated Heavy-Weight | | Softon 2200 | 20.00 | 20.00 | 20.00 | 20.00 | 20.00 |
| Calcium Carbonate | | | | | | | |
| Adhesion Enhancer/Catalyst | | GENIOSIL ® GF96 | 1.00 | 1.00 | 1.00 | 1.00 | 1.00 |
| Diluent Viscosity (mPa · s/25° C.) | | | About | 60~80 | About | About | 60~80 |
| | | | 336 | | 73 | 336 | |
| Viscosity (×10³ | 10 (1/S) | <100 | 88 | 70 | 62 | 70 | 48 |
| mPa · s) | | (Workability) | | | | | |
| | 2 (1/S) | 250< | 470 | 344 | 379 | 394 | 210 |
| | | (Shifting-Property) | | | | | |

| | | | | | |
|---|---|---|---|---|---|
| Workability with Combing Trowel | B | B | B | B | A |
| Ceramic Tile-Shifting Property | A | A | A | A | B |

| | Compar- | Compar- | Compar- | Compar- |
|---|---|---|---|---|
| | ative | ative | ative | ative |
| Amount in Parts by Mass of Each Component | Example 2 | Example 3 | Example 4 | Example5 |

| Silane-Terminated Modified Polymer | | | GENIOSIL ® STP-E10 | 8.75 | 8.75 | 8.75 | 48.00 |
|---|---|---|---|---|---|---|---|
| | | | (Mn = 12,000 g/Mol) | | | | |
| | | | Silane-Terminated | | | | |
| | | | Modified Polymer | | | | |
| | | | (Mn = 4,000 g/Mol) | | | | |
| Surface-Treated Hydrophobized Silica | | | HDK H18 | 3.00 | 3.00 | 3.00 | 3.00 |
| Polyamide Wax | | | A-S-A ® T-1700 | 1.50 | 1.50 | 1.50 | 1.50 |
| Diluent | High | Having Hydrophobic | GENIOSIL ® IC368 | | | | |
| | Viscosity | Moiety and | Polypropylene Glycol | | | | |
| | | Hydrophilic Moiety | GENIOSIL ® IC678 | | | | |
| | | Having Only | WACKER ® AK 350 | 39.25 | | | |
| | | Hydrophobic Moiety | | | | | |
| | Low | Having Hydrophobic | SILRES ® BS1316 | | 39.25 | | |
| | Viscosity | Moiety and | | | | | |
| | | Hydrophilic Moiety | | | | | |
| | | Having Only | n-Hexane | | | 39.25 | |
| | | Hydrophobic Moiety | | | | | |

| Curing Rate-Adjusting Agent | | WACKER ® TES40 | 1.20 | 1.20 | 1.20 | 1.20 |
|---|---|---|---|---|---|---|
| Dehydrating Agent | | GENIOSIL ® XL10 | 2.00 | 2.00 | 2.00 | 2.00 |
| Adhesion Enhancer | | GENIOSIL ® GF80 | 2.00 | 2.00 | 2.00 | 2.00 |
| Stabilizer | | Tinuvin ® B75 | 1.00 | 1.00 | 1.00 | 1.00 |
| Synthesis Calcium Carbonate | | Viscolite-EL20 | 21.80 | 21.80 | 21.80 | 21.80 |
| Surface-Untreated Heavy-Weight | | Softon 2200 | 20.00 | 20.00 | 20.00 | 20.00 |
| Calcium Carbonate | | | | | | |
| Adhesion Enhancer/Catalyst | | GENIOSIL* GF96 | 1.00 | 1.00 | 1.00 | 1.00 |
| Diluent Viscosity (mPa · s/25° C.) | | | 324~356 | About | About | — |
| | | | | 2 | 0.3 | |
| Viscosity (×10³ | 10 (1/S) | <100 | —* | 28 | 37** | 418 |
| mPa · s) | | (Workability) | | | | |
| | 2 (1/S) | 250< | —* | 114 | 207** | 969 |
| | | (Shifting-Property) | | | | |

| | | | | |
|---|---|---|---|---|
| Workability with Combing Trowel | —* | A | B** | C |
| Ceramic Tile-Shifting Property | —* | B | B** | A |

Criteria for evaluation of workability with combing trowel: A: very light load, B: light load, C: heavy load
Criteria for evaluation of ceramic tile-shifting property: A: shift does not occur, B: shift occurs
*The compatibility of a polymer with a diluent was poor, and separation occurred. The viscosity was not measured, and the workability with combing trowel and the shifting property were not evaluated.
**After application with a combing trowel, the whole surface of a coating film was cracked, and all ceramic tiles were peeled and fallen.

1-9. (canceled)

10. A moisture-curable composition comprising:
a polymer (A) having a hydrophobic moiety and a hydrophilic moiety as a main component;
a diluent (B) having a hydrophobic moiety and a hydrophilic moiety and a viscosity of higher than 10 mPa·s;
a hydrophobized inorganic particle (C); and
a thixotropic agent (D) having a hydrophobic moiety and a hydrophilic moiety,
the moisture-curable composition exhibiting performance of suppressing a viscosity at a high shear rate to a value equal to or lower than a certain value and increasing a viscosity at a low shear rate wherein the polymer (A) is a silane-terminated modified polymer (A) represented by the following general formula (1),
Y—[(CR¹₂)_{b}—SiRₐ(OR²)₃₋ₐ]ₓ (1),
where in the general formula (1) Y is an x-valent organic polymer group bonded via nitrogen, oxygen, sulfur or carbon, and containing a polyoxyalkylene or a polyurethane as a polymer chain,
R may be the same or different and is a monovalent, optionally substituted SiC-bonded hydrocarbon group,
R¹ may be the same or different and is a hydrogen atom or a monovalent, optionally substituted hydrocarbon group in which a carbon atom can be boned to nitrogen, phosphorus, oxygen, sulfur or a carbonyl group,
R² may be the same or different and is a hydrogen atom or a monovalent, optionally substituted hydrocarbon group,
x is an integer of 1 to 10,
a is 0, 1, or 2, and
b is an integer of 1 to 10;
a diluent (B) having a predetermined viscosity range;
a hydrophobized inorganic particle (C); and
a thixotropic agent (D) having a hydrophobic moiety and a hydrophilic moiety.

11. The moisture-curable composition according to claim 10, wherein an end group of the polymer (A) is one represented by the general formula (2) or general formula (3):
—O—C(═O)—NH—(CR¹₂)_{b}—SiRₐ(OR²)₃₋ₐ (2)
—NH—C(═O)—NR′—(CR¹₂)_{b}—SiRₐ(OR²)₃₋ₐ (3),
where in the general formulas (2) and (3) each of the groups and subscripts has one of the definitions specified in the general formula (1),
R may be the same or different and is a monovalent, optionally substituted SiC-bonded hydrocarbon group, and
R′ may be the same or different and has a given definition for R.

12. The moisture-curable composition according to claim 10, wherein the diluent (B) is a silicone resin containing a unit represented by the following general formula (4):
R³_{c}(R⁴O)_{d}R⁵ₑSiO_{(4-c-d-e)/2} (4),
where in the general formula (4)
R³ may be the same or different and is a hydrogen atom, a monovalent, SiC-bonded and optionally substituted aliphatic hydrocarbon group, or a divalent, optionally substituted aliphatic hydrocarbon group that crosslinks two units represented by the formula (4),
R⁴ may be the same or different and is a methyl group or an ethyl group,
R⁵ may be the same or different and is a monovalent, SiC-bonded and optionally substituted aromatic hydrocarbon group,
c is 0, 1, 2, or 3,
d is 0, 1, 2, 3, or 4, and
e is 0, 1, or 2.

13. The moisture-curable composition according to claim 10, wherein the hydrophobized inorganic particle (C) is hydrophobized silica, and the thixotropic agent (D) is an amide wax.

14. The moisture-curable composition according to claim 10, wherein the moisture-curable composition is a composition containing the following components:
(A) the silane-terminated modified polymer represented by the general formula (1): 5 to 90 parts by mass,
(B) the diluent: 5 to 50 parts by mass,
(C) the hydrophobized inorganic particle: 0.1 to 20 parts by mass,
(D) the thixotropic agent: 0.1 to 10 parts by mass,
(E) an amine compound: 0.01 to 10 parts by mass,
(F) a dehydrating agent: 0 to 10 parts by mass,
(G) a stabilizer: 0.01 to 5 parts by mass,
(H) a filler: 0 to 80 parts by mass, and
(I) a catalyst: 0 to 5 parts by mass,
provided that amount in parts by mass of each component represents an amount in parts by mass of each component relative to 100 parts by mass of the whole moisture-curable composition.

15. A method for producing a moisture-curable composition comprising:
an amide wax kneading step of adding a silane-terminated modified polymer (A) to an amide wax content, and kneading the mixture; and
an inorganic particle kneading step of mixing a diluent with the amide wax-containing mixture obtained in the amide wax kneading step to decrease a viscosity thereof, and then mixing and kneading hydrophobized inorganic particles.

16. The method for producing a moisture-curable composition according to claim 15, wherein
the amide wax kneading step includes
a first step of adding the silane-terminated modified polymer (A) in an amount of 1 to 2 times the amide wax content, and adjusting a mixed amide wax masterbatch, and
a second step of mixing a rest of the silane-terminated modified polymer (A) to the amide wax masterbatch to obtain an amide wax-containing mixture.
